(19) United States
(12) Patent Application Publication
(10) Pub. No.: US 2002/0144164 A1
(43) Pub. Date: Oct. 3, 2002

(54) Efficiency-raising and power-saving procedure and its devices

(76) Inventor: Yu-Nan Chen, TaoYuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/781,428

(22) Filed: Feb. 13, 2001

(51) Int. Cl. G06F 1/26; G06F 1/32

(52) U.S. Cl. 713/320

(57) ABSTRACT

The present invention relates to an efficiency-raising and power-saving procedure and its devices which features the following steps: (a) an efficiency-raising device being series-connected between the AC power and an equipment for detecting the current value and the actual power of the equipment, and. the efficiency-raising device actuating a voltage-adjusting mechanism for changing the voltage from the input side to the load side; (b) to use a detection instrument for detecting the efficiency of the equipment at the load side; (c) to calculate the optimal efficiency (%) and the corresponding voltage value and the actual power factor (KWH) under different load rates of the equipment and to detect the corresponding current value thereof; (d) to input the above detected voltage value (V), the efficiency (%), the actual power factor (KWH) and the current value (A) under different circumstances into a microprocessor for storage; (e) to detect the newest current value by means of the efficiency-raising device when the loaded rate of the equipment is changed while the microprocessor immediately calculates the voltage value corresponding to the optimal actual power factor (KWH) of the optimal efficiency thereof; and (f) to actuate a voltage-adjusting mechanism of the efficiency-raising device so that the voltage is adjusted to the level required at the optimal actual power factor (KWH). Accordingly, the voltage of the equipment is adjustable in accordance with its different load in order to obtain its optimal efficiency, thereby reaching the power-saving effect.

### BACKGROUND OF THE INVENTION

1. Field of the Invention

The present invention relates to an efficiency-raising and power-saving procedure and its devices, and more particularly to a procedure in that the voltage of an equipment is adjustable in accordance with its different load in order to obtain its optimal efficiency, thereby reaching the power-saving effect.

2. Description of the Prior Art

The progress of the civilization and the innovation of the technology are totally owing to the invention of the electricity. However, the cost of the raw material (e.g. coal, petroleum, natural gas, nuclear power, etc.) to produce the electricity increases degree by degree, and power resources will be exhausted someday. Although part of the electric energy is obtained from the solar energy, it is still not a main source for producing the electricity. People increasingly used the electricity. In addition to building the power plants, the design of both industrial equipment and household appliances are aimed at low energy consumption.

The present electric charge is calculated in accordance with the following formula:

KWH=V I cosθ

(KWH: actual power; V=voltage; I=current; cosθ=power factor)

The present power-saving ways are described as follows:

1. To improve the power factor

Does the increase of the power factor benefit the users? The increase of the power factor will offset the decrease of V I. The power factor is included in the calculation of the electric charge. When the power factor is more than 0.8, the electric charge will be reduced according to the actual power factor. When it is less than 0.8, more electric charge will be asked. As a result, the improvement of the power factor can't reduce the actual use rate, even offsets the partial effect of the voltage-reduced operation. However, it can be compensated by the partially reduced electric charge. Moreover, the advantage of the improvement of the power factor is to raise the use rate of the equipment and to reduce the line loss. However, the effect of this power-saving way is very limited in improving the use of the electricity.

2. To reduce the voltage

The effect of the direct voltage-reducing way performed by a step-down transformer or other voltage-reducing electric parts is significant. Especially, it's applicable to the fluorescent lamp. However, this way still has its drawback. The voltage supplied by the power plant is frequently lower during the peak load. The voltage will be too low by means of the voltage-reducing way so that the equipment can't be actuated or the use efficiency of the equipment is worsened. Thus, more power will be consumed.

3. To stabilize the voltage

This way can improve the drawback of the direct voltage-reducing way and the too low voltage supplied by the power plant during the peak load. However, when this way (to stabilize the voltage at a lower level than the nominal level) applies to the electrodynamic, inductive motors or compressors which are used at the starting moment or used to full load, the original efficiency of the equipment can't be reached, thereby consuming more current.

4. To change the frequency

To change the frequency is used to reduce the rotational speed of the normal electrodynamic motors, thereby reaching the power-saving effect. Currently, it can only be used for the reduction of the rotational speed, without worsening the efficiency of the AC motors; moreover, the efficiency thereof should be fixed. If the efficiency is changeable, this way doesn't work.

Additionally, the existing power-saving equipment can only be used to the resistant load (e.g. lighting equipment). Presently, no better power-saving way is available for the air-conditioners and freezers.

According to the law of conservation of energy, when the equipment is operated to the efficiency limit (100%), it's impossible to have the power-saving space no matter which way is used. To the contrary, in order to reach the maximal power efficiency of an equipment, a nominal voltage value should be supplied. Consequently, we ensure that all electrodynamic and inductive equipments hardly have the power-saving space when the load rate amounts to the maximal level. To the contrary, when the equipment is not fully loaded, the efficiency-raising and power-saving space are available.

In other words, when the load rate of some equipment is below a certain level at certain period or under special circumstance, a better efficiency thereof can be obtained by some ways for reaching the power-saving effect. This is the main topic of the present invention.

### SUMMARY OF THE INVENTION

It is a primary object of the present invention to provide an efficiency-raising and power-saving procedure and its devices, wherein the voltage of an equipment is adjustable in accordance with its different load in order to obtain its optimal efficiency.

It is another object of the present invention to provide an efficiency-raising and power-saving procedure and its devices, wherein the power-saving effect is attainable in reaching the optimal efficiency.

### BRIEF DESCRIPTION OF THE DRAWINGS

The accomplishment of this and other objects of the invention will become apparent from the following description and its accompanying drawings of which:

FIG. 1 is a block diagram of the devices of the present invention;

FIG. 2 is a logic block diagram of the voltage adjustment of the present invention;

FIG. 3 is a data table of the voltage, current and efficiency under different load rates of a commercially available motor; and

FIG. 4 is a comparison table of the voltage change and the power consumption of a commercially available motor.

Additionally, six pages of test reports of an induction motor are attached for information.

### DETAILED DESCRIPTION OF THE PREFERRED EMBODIMENT

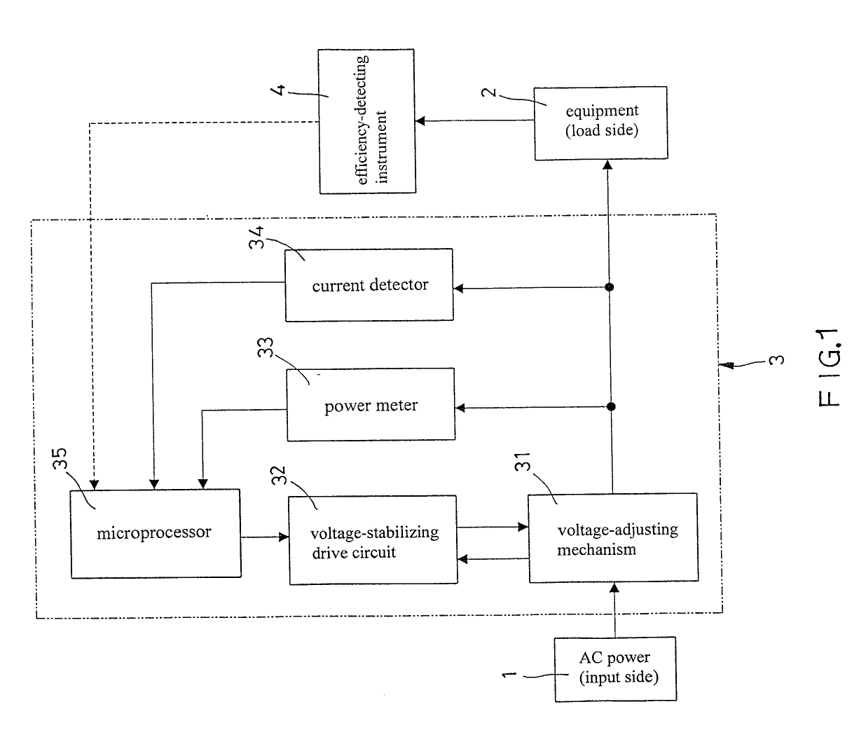

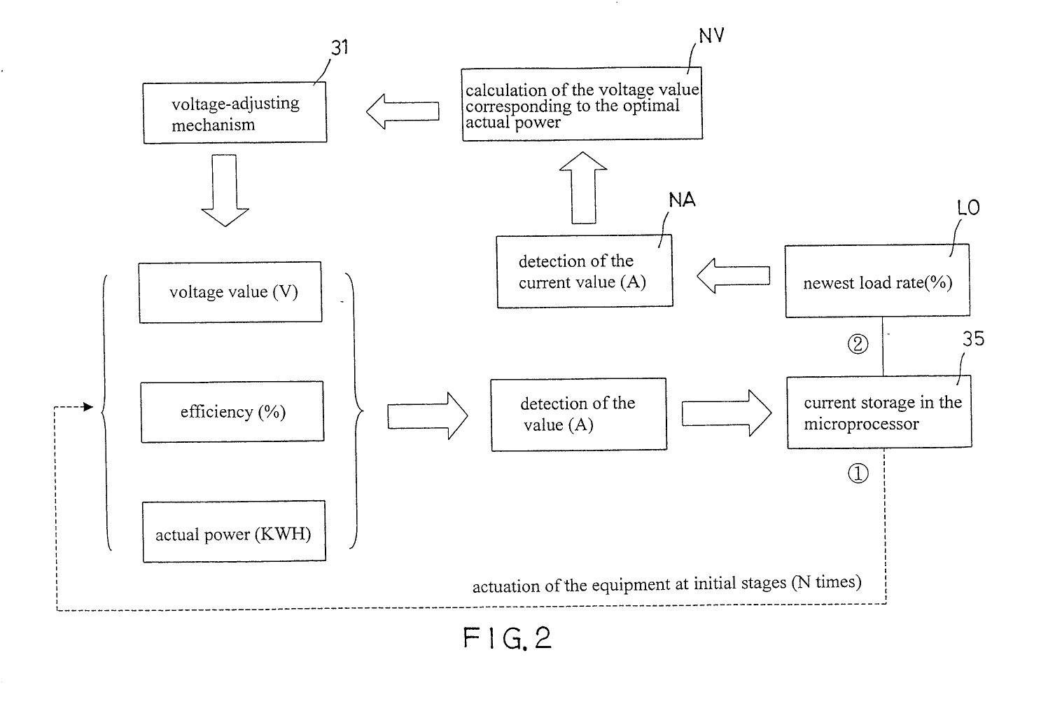

First of all, referring to FIGS. 1 and 2, the efficiency-raising and power-saving procedure in accordance with the present invention are used for the low-loaded equipment or the equipment with unstable load rate. The voltage is suitably adjusted in accordance with the different load rates of the equipment in order to obtain an optimal efficiency thereof for reaching the power-saving effect. Meanwhile, the measured current value is used as basic point (comparison value) for control. It features the following steps:

(a) An efficiency-raising device 3 is series-connected between the AC power 1 and the equipment 2 for detecting the current value and the actual power of the equipment 2. In addition, it can actuate a voltage-adjusting mechanism for changing the voltage from the input side 1 to the load side 2;

(b) To use a detection instrument 4 for detecting the efficiency of the equipment 2 at the load side;

(c) To calculate the optimal efficiency (%) and the corresponding voltage value and the actual power factor (KWH) under different load rates of the equipment 2 and to detect the corresponding current value thereof;

(d) To input the above detected voltage value (V), the efficiency (%), the actual power factor (KWH) and the current value (A) under different circumstances into a microprocessor 35 for storage;

(e) To detect the newest current value by means of the efficiency-raising device 3 when the loaded rate of the equipment 2 is changed while the microprocessor 35 immediately calculates the voltage value corresponding to the optimal actual power factor (KWH) of the optimal efficiency thereof; and

(f) To actuate a voltage-adjusting mechanism 31 of the efficiency-raising device 3 so that the voltage is adjusted to the level required at the optimal actual power factor (KWH).

The efficiency-raising device 3 includes:

a voltage-adjusting mechanism 31 composed of a voltage regulator, a power-saving device or an equivalent voltage-adjusting machine;

a voltage-stabilizing drive circuit 32 used for driving the voltage-adjusting mechanism 31 and for stabilizing the circuit;

a power meter 33 used for detect the input voltage (KWH) during the optimal efficiency of the equipment 2 at the load side while the signal is sent to the microprocessor 35;

a current detector 34 used for detecting the current value (A) of the equipment 2 at the load side; and

a microprocessor 35 having at least a current-detecting storage circuit, a current-to-voltage circuit and a comparing-corresponding circuit to the current, voltage and efficiency and saving the aforementioned data so that the newest current value can be detected and the voltage value corresponding to the optimal use efficiency is calculated when the load rate of the equipment 2 is changed while the voltage-adjusting mechanism 31 is actuated by the voltage-stabilizing drive circuit 32 for supplying the equipment 2 with the most proper corresponding voltage value.

Moreover, the load side of the present invention is equipped with an efficiency-detecting instrument 4 in accordance with the function of the equipment 2 to be detected. For example, a torsion meter is used for detecting the torsion efficiency; a rotational meter is used for detecting the rotational speed of the equipment. Furthermore, there are anemograph, pressure meter, gravimeter, etc. These are commercially available instruments and not the object of the present invention so that it won't be described more hereinafter.

In using the method and devices of the present invention, the efficient and the power-saving rate of the equipment can be raised when it is low-loaded. For example, a motor is loaded at the rate of 50%, and an optimal efficiency (%) is not necessarily obtainable when a standard voltage 220V is supplied. Consequently, if the voltage value required by the optimal efficiency of any equipment and the corresponding current value and the actual power are obtained in advance and saved, the newest current value (A) can be detected when the load rate is changed so that the corresponding voltage (V) to the optimal efficiency can be calculated while the voltage-adjusting mechanism 31 is actuated to adjust the voltage to the optimal level (e.g. 200V). For example, when the equipment 2 is only loaded at the rate of 35% and supplied with 220V, the efficiency rate of doing work is 77%; when it's supplied with 200V, the efficiency rate of doing work is 79% so that the efficiency is raised at 2%. And the input power at 220V is 400W while the input power at 200V is 380W so that the power-saving rate is 5%. As a result, when the load rate of the equipment is changed and the voltage can be properly adjusted, the optimal efficiency and its power-saving effect of the equipment are attainable.

However, the load rate of the equipment is changeable at any time. Therefore, how to obtain the voltage value corresponding to the optimal efficiency is the main topic of the present invention. As shown in FIG. 2, when the load rate (LO) is changed, the current detector 34 detects the newest current value (NA) of the equipment 2 while the voltage value (NV) corresponding to the optimal actual rate at the optimal efficiency will be calculated by the microprocessor 35 immediately. As a result, the voltage-adjusting mechanism 31 is actuated to adjust the standard voltage (about 220V) to the voltage value (V) required at the optimal actual power. This voltage value (V) can be 210V or 200V. If it's 200V, the power value sent by the voltage-adjusting mechanism 31 to the equipment 2, as shown in FIG. 1, is 200V. Accordingly, the power-saving effect is attainable and the equipment 2 can exert its optimal efficiency.

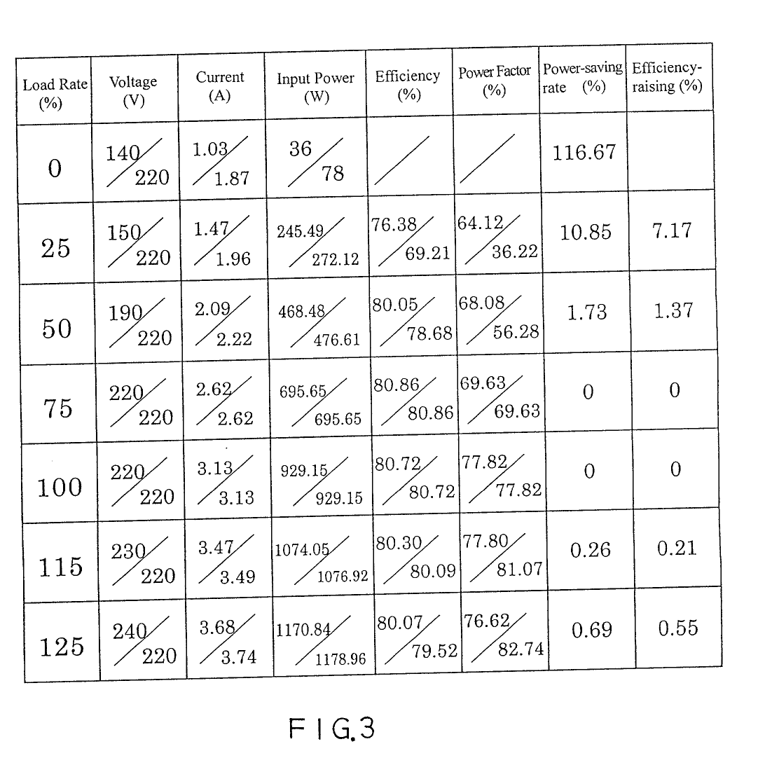

In order to prove the present invention is applicable, actual data are shown in FIG. 3. A commercially available Teco motor is supplied with the optimal voltage value (V) at different load rates. The value above the sign (/) is the optimal voltage while the value under the sign (/) is the standard voltage. At the null load rate (0%), it's apparent from the table that the current value is 1.87A and the input power is 78W when the load rate is 0% and the standard voltage is 220V, and the current value is 1.03A and the input power is 36W when the load rate is 0% and the standard voltage is 140V. Therefore, the idle rotation requires only 140V instead of 220V so that the power-saving rate is 116.67%.

Moreover, at the load rate 25%, the relevant data are shown as follows:

| Voltage | Current | Input Power | Efficiency | Power Factor | Power-saving | Efficiency- |
|---|---|---|---|---|---|---|
| (V) | (A) | (W) | (%) | (%) | rate (%) | raising (%) |
| 150/220 | 1.47/1.96 | 245.49/272.12 | 76.38/69.21 | 64.12/36.22 | 10.85 | 7.17 |

It's apparent from the above table that the current value is 1.96A, the input power is 272.12W, the efficiency is 69.21% and the power factor is 36.22% when the load rate is 25% and the standard voltage is 220V. However, when the optimal voltage is 150V, the power can be saved at 10.85% (calculated by the input power) and the efficiency can be raised at 7.17%. Accordingly, when the load rate is 25% and the input voltage is 220V, the efficiency rate is only 69.21% and the power-consumption is 272.12W. At the other side, the voltage corresponding to the optimal efficiency (76.38%) is 150V. Not only can the efficiency be raised at 7.17%, but also the power (26.63W=272.12-245.49) can be saved at 10.85%.

Accordingly, the efficiency-raising and power-saving procedure and its devices can be reached at different voltages when the load rate is 50% or 40%. The data shown in FIG. 3 are obtained from the attachment 1: test report of induction motor. Please refer to the test report of commercially available Teco motor for 1.00 HP and it won't be described more hereinafter.

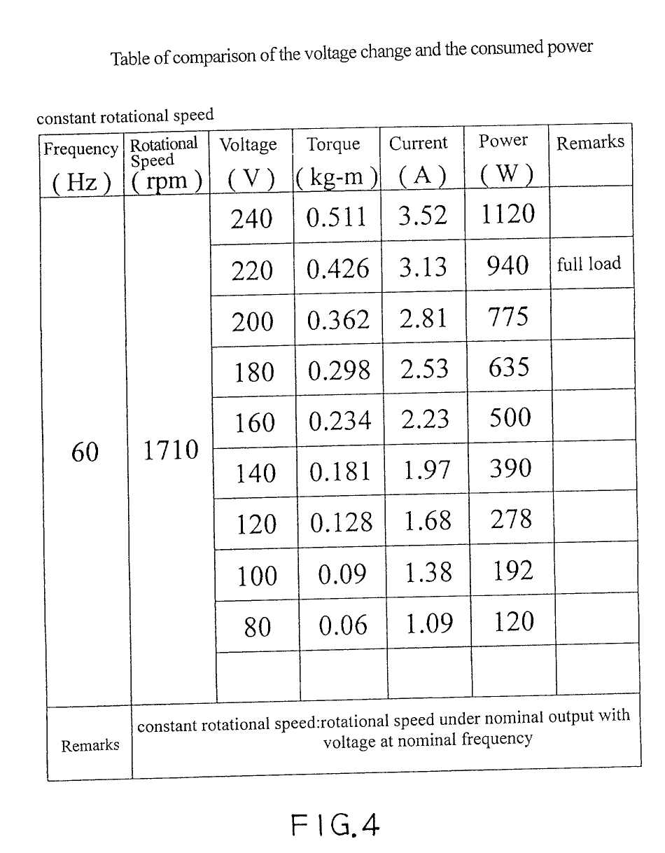

Referring to FIG. 4, the motor is constantly rotated at 1710 rpm. When the voltage (220V) is at full load, its torque is 0.426 kg-m, the current value 3.13A and the input power 940W. When the torque is only 0.362 kg-m, the detected current value is 2.81A, the input power 775W so that the corresponding voltage value is 200V. Thereafter, the microprocessor 35 commands the voltage-adjusting mechanism 31 to adjust the voltage value to 200V, thereby sending to the equipment (motor). Accordingly, the efficiency-raising and power-saving effect is attainable. Many motors are loaded under 50% so that the present invention is applicable for reaching the expected effect.

It's apparent from FIG. 3 that the efficiency-raising and power-saving effects are hardly attainable at the load rate of 75% or 100%. However, the data in FIG. 3 are completed in the laboratory and the standard voltage is set at 220V. In the reality, the voltages supplied by the power plant during the peak and valley period differ much from each other. During the peak period, the voltage can amount to 1240V while it is less than 190V during the valley period. Consequently, the power-saving space is still existing. Even the power-saving efficiency is very limited at high load, the present invention can be used as voltage stabilizer under the circumstances of great change of voltage supplied by the power plant. Therefore, the equipment 2 is supplied with a stable voltage to ensure the efficiency of doing work and its service life.

From the aforementioned method and the experimental data, the efficiency of any equipment can be enhanced by reducing the voltage when the load rate is changed, thereby reaching the power-saving effect. However, the adjustment of voltage should be performed under the circumstance without affecting the optimal efficiency completed by the equipment. Accordingly, when the load rate is changed, the newest current value detected in a moment is used as a basic point for control. Therefore, the voltage will be rapidly adjusted by the voltage-adjusting mechanism 31 to the optimal level required by the optimal actual power for reaching both efficiency-raising and power-saving effects.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An efficiency-raising and power-saving procedure and its devices, wherein the voltage of an equipment is properly adjusted in accordance with the different load rates for reaching the optimal efficiency of the equipment and the power-saving effect thereof, and the current value detected at that moment is used as a basic point for control, and
wherein the present invention is characterized by the following steps:
(a) an efficiency-raising device being series-connected between the AC power and said equipment for detecting the current value and the actual power of said equipment, and said efficiency-raising device actuating a voltage-adjusting mechanism for changing the voltage from the input side to the load side;
(b) to use a detection instrument for detecting the efficiency of said equipment at the load side;
(c) to calculate the optimal efficiency (%) and the corresponding voltage value and the actual power factor (KWH) under different load rates of said equipment and to detect the corresponding current value thereof;
(d) to input the above detected voltage value (V), the efficiency (%), the actual power factor (KWH) and the current value (A) under different circumstances into a microprocessor for storage;
(e) to detect the newest current value by means of said efficiency-raising device when the loaded rate of said equipment is changed while said microprocessor immediately calculates the voltage value corresponding to the optimal actual power factor (KWH) of the optimal efficiency thereof; and
(f) to actuate a voltage-adjusting mechanism of said efficiency-raising device so that the voltage is adjusted to the level required at the optimal actual power factor (KWH).

2. An efficiency-raising device series-connected between the AC power and said equipment includes:
a voltage-adjusting mechanism composed of a voltage regulator, a power-saving device or an equivalent voltage-adjusting machine;
a voltage-stabilizing drive circuit used for driving said voltage-adjusting mechanism 31 and for stabilizing the circuit;
a power meter used for detect the input voltage (KWH) during the optimal efficiency of said equipment at the load side while the signal is sent to said microprocessor;
a current detector used for detecting the current value (A) of said equipment at the load side; and
a microprocessor having at least a current-detecting storage circuit, a current-to-voltage circuit and a comparing-corresponding circuit to the current, voltage and efficiency and saving the aforementioned data so that the newest current value can be detected and the voltage value corresponding to the optimal use efficiency is calculated when the load rate of said equipment is changed while said voltage-adjusting mechanism is actuated by said voltage-stabilizing drive circuit for supplying said equipment with the most proper corresponding voltage value.

3. The efficiency-raising device as claimed in claim 2, wherein the load side is equipped with an efficiency-detecting instrument used for detecting the optimal efficiency of said equipment while the detected signal is sent to said microprocessor.
